(19) United States
(12) Patent Application Publication
(10) Pub. No.: US 2008/0306949 A1
(43) Pub. Date: Dec. 11, 2008

(54) INVERTED INDEX PROCESSING

(76) Inventors: John Martin Hoernkvist, Cupertino, CA (US); Eric Richard Koebler, Aptos, CA (US); Wayne Loofbourrow, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/760,673

(22) Filed: Jun. 8, 2007

(51) Int. Cl. G06F 7/08; G06F 12/02

(52) U.S. Cl. 707/7; 711/171; 707/E17.033; 711/E12.002

(57) ABSTRACT

Systems and methods for processing an index are described. In one exemplary method, a 2-level term table and postings table is used to generate postings lists. The postings lists are optimally stored in a postings file. Update sets for an index are optimally processed to update a index to a storage medium using flushing.

### BACKGROUND

Modern data processing systems, such as general purpose computer systems, allow the users of such systems to create a variety of different types of data files. For example, a typical user of a data processing system may create text files with a word processing program such as Microsoft Word or may create an image file with an image processing program such as Adobe's PhotoShop. Numerous other types of files are capable of being created or modified, edited, and otherwise used by one or more users for a typical data processing system. The large number of the different types of files that can be created or modified can present a challenge to a typical user who is seeking to find a particular file which has been created.

Modern data processing systems often include a file management system which allows a user to place files in various directories or subdirectories (e.g. folders) and allows a user to give the file a name. Further, these file management systems often allow a user to find a file by searching not only the content of a file, but also by searching for the file's name, or the date of creation, or the date of modification, or the type of file. An example of such a file management system is the Finder program which operates on Macintosh computers from Apple Computer, Inc. of Cupertino, Calif. Another example of a file management system program is the Windows Explorer program which operates on the Windows operating system from Microsoft Corporation of Redmond, Wash. Both the Finder program and the Windows Explorer program include a find command which allows a user to search for files by various criteria including a file name or a date of creation or a date of modification or the type of file. This search capability searches through information which is the same for each file, regardless of the type of file. Thus, for example, the searchable data for a Microsoft Word file is the same as the searchable data for an Adobe PhotoShop file, and this data typically includes the file name, the type of file, the date of creation, the date of last modification, the size of the file and certain other parameters which may be maintained for the file by the file management system.

Certain presently existing application programs allow a user to maintain data about a particular file. This data about a particular file may be considered metadata because it is data about other data. This metadata for a particular file may include information about the author of a file, a summary of the document, and various other types of information. Some file management systems, such as the Finder program, allow users to find a file by searching through the metadata.

In a typical system, the various content, file, and metadata are indexed for later retrieval using a program such as the Finder program, in what is commonly referred to as an inverted index. For example, an inverted index might contain a list of references to documents in which a particular word appears. Given the large numbers of words and documents in which the words may appear, an inverted index can be extremely large. The size of an index presents many challenges in processing and storing the index, such as updating the index or using the index to perform a search.

### SUMMARY OF THE DETAILED DESCRIPTION

Methods and systems for processing an inverted index in a data processing system are described herein.

According to one aspect of the invention, a 2-level table is used for inverting an index. Since some terms occur far more commonly than others, a smaller table contains a subset of the more frequently occurring terms, and a larger table contains terms that occur rarely. An algorithm may be employed to determine whether terms occurring in the item should be indexed using the smaller table of frequently occurring terms or the larger table of terms that occur rarely. For example, the algorithm may include calculating the frequency with which a term occurs in the item or across all items. Because the smaller table will be updated more often than the larger table, the smaller table is generally optimized for updating, i.e., for making room in the table for inserts, whereas the larger table is generally not optimized for updating. The 2-level table may be used for an index of a single item or a corpus of items and decreases memory pressure and increases performance.

According to one aspect of the invention, a postings file containing one or more postings lists is updated in reverse order. Each item in a postings list is updated with a pointer that points to the previous item that was entered for that term. As a result, old data in the postings file is referenced from new data, thus avoiding writing over old data and using a minimum memory footprint. When the space allocated for the postings file is exhausted, a new space is allocated and also updated in reverse order. Because each item in the postings list is updated with the pointer that points to the previous item that was entered for that term, the first entry for each postings list in the new space is updated with a pointer that points to the last entry that was entered for that term's postings list in the old space. As a result, during access, the postings file may be efficiently read in the forward direction, with the occasional large jump backwards in the file, accrued over many forward reads, instead of making many small backwards reads.

According to one aspect of the invention, the postings entries in the postings file are stored in term order. In some cases, the most recent posting may be stored in a table, such as the smaller 2-level term table, allowing fast term frequency calculation. The most recent posting is updated to point to the next posting for that term in the postings file. Lastly, because updates are appended to the postings file, and because the file is written before updating the pointers into it, access to the file can be done without locks.

According to one aspect of the invention, an updates set of an index are flushed to minimize memory use and maximize disk bandwidth. Flushing includes, among other actions, sorting the update set in string order, and obtaining the page offsets for each string. The update set entries may then be grouped by their page offsets and resorted into page offset major order and string sorted minor order, and inserted in to the index in that order so that the store pages of the index are accessed in disk block order, thus minimizing memory use and maximizing disk bandwidth. In this manner, a single cursor may be used to point to the last accessed location in the page to decrease search time for string insertion.

### BRIEF DESCRIPTION OF THE DRAWINGS

The present invention is illustrated by way of example and not limitation in the figures of the accompanying drawings in which like references indicate similar elements.

FIG. 1 is a block diagram overview of an architecture for processing an inverted index according to one exemplary embodiment of the invention.

FIG. 2 illustrates two levels of term tables used for processing an inverted index according to one exemplary embodiment of the invention.

FIGS. 3A-3B illustrate one aspect of processing an inverted index according to one exemplary embodiment of the invention.

FIG. 4 illustrates another aspect of processing an inverted index according to one exemplary embodiment of the invention.

FIG. 5 illustrates another aspect of processing an inverted index according to one exemplary embodiment of the invention.

FIG. 6 is a block diagram overview illustrating another aspect of processing an inverted index according to one exemplary embodiment of the invention.

FIGS. 7-9 are flow diagrams illustrating certain aspects of performing a method or processing an inverted index according to one exemplary embodiment of the invention.

FIG. 10 is a block diagram overview of an exemplary embodiment of a data processing system, which may be a general purpose computer system and which may operate in any of the various methods described herein.

### DETAILED DESCRIPTION

The embodiments of the present invention will be described with reference to numerous details set forth below, and the accompanying drawings will illustrate the described embodiments. As such, the following description and drawings are illustrative of embodiments of the present invention and are not to be construed as limiting the invention. Numerous specific details are described to provide a thorough understanding of the present invention. However, in certain instances, well known or conventional details are not described in order to not unnecessarily obscure the present invention in detail.

The present description includes material protected by copyrights, such as illustrations of graphical user interface images. The owners of the copyrights, including the assignee of the present invention, hereby reserve their rights, including copyright, in these materials. The copyright owner has no objection to the facsimile reproduction by anyone of the patent document or the patent disclosure, as it appears in the Patent and Trademark Office file or records, but otherwise reserves all copyrights whatsoever. Copyright Apple Computer, Inc. 2007.

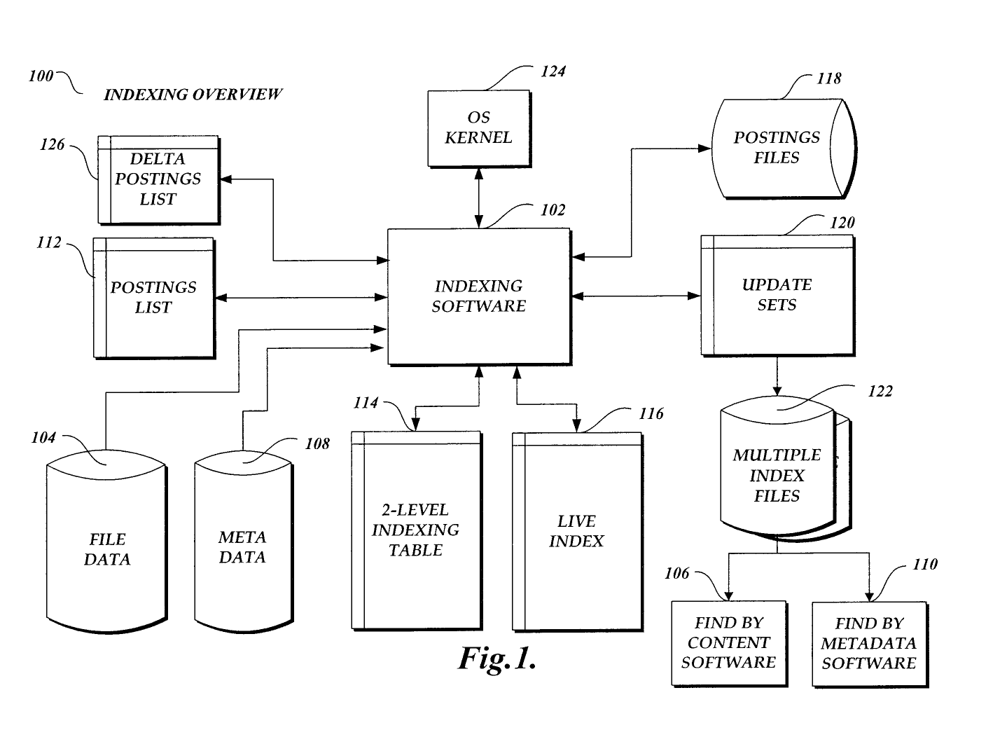

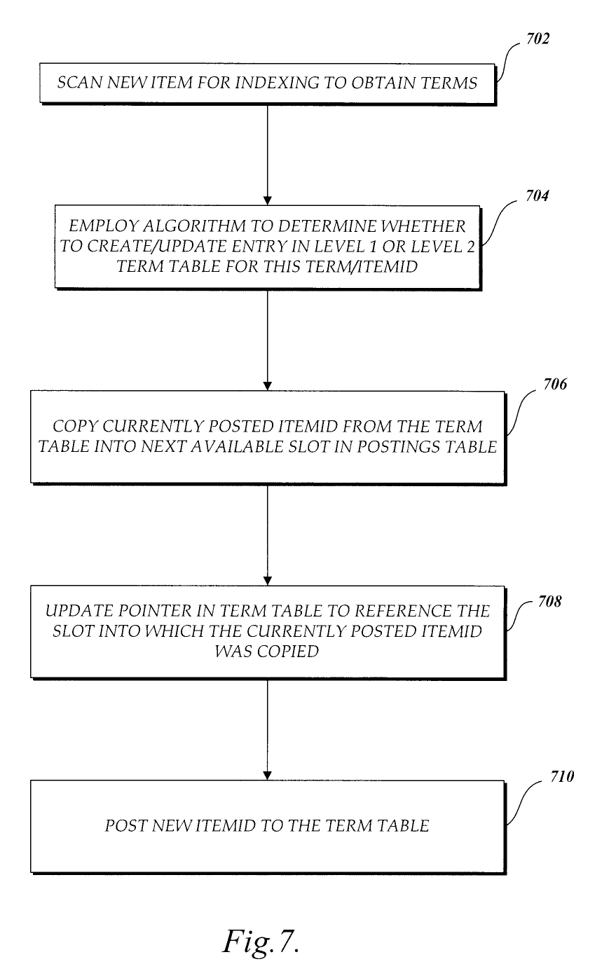

Various different software architectures may be used to implement the functions and operations described herein, such as to perform the methods shown in FIGS. 7-9. The following discussion provides one example of such an architecture, but it will be understood that alternative architectures may also be employed to achieve the same or similar results. The software architecture 100 shown in FIG. 1 is an example which is based upon the Macintosh operating system. The architecture 100 includes indexing software 102 and an operating system (OS) kernel 124 which is operatively coupled to the indexing software 102, as well as other software programs, such as find by content software 106 and find by metadata software 110 (which may be the Finder program referenced earlier), and other applications not shown.

In one exemplary embodiment, the find by content software 106 and/or the find by metadata software 110 is used to find a term present in the file data 104 or meta data 108. For example, the software 106/110 may be used to find text and other information from word processing or text processing files created by word processing programs such as Microsoft Word, etc.

The find by content software 106 and find by metadata software 110 are operatively coupled to databases which include one or more indexes 122. The indexes 122 represent at least a subset of the data files in a storage device, including file data 104 and meta data 108, and may include all of the data files in a particular storage device (or several storage devices), such as the main hard drive of a computer system. The one or more indexes 122 comprise an indexed representation of the content and/or metadata of each item stored on the data files 104/108, such as a text document, music, video, or other type of file. The find by content software 106 searches for a term in that content by searching through the one or more index files 122 to see if the particular term, e.g., a particular word, is present in items stored on data files 104 which have been indexed. The find by content software functionality is available through find by metadata software 110 which provides the advantage to the user that the user can search the indexes 122 for the content 104 within an item stored on the data files 104 as well as any metadata 108 that may have been generated for the item.

In one embodiment of the present invention, indexing software 102 is used to create and maintain the one or more indexes 122 that are operatively coupled to the find by content and metadata software applications 106/110. Among other functions, the indexing software 102 receives information obtained by scanning the file data 104 and meta data 108, and uses that information to generate a postings list 112 that identifies an item containing a particular term, or having metadata containing a particular term. As such, the postings list 112 is a type of inverted index that maps a term, such as a search term, to the items identified in the list. In a typical embodiment, the information obtained during the scan includes a unique identifier that uniquely identifies the item containing the particular term, or having metadata containing the term. For example, items such as a word processing or text processing file have unique identifiers, referred to as ITEMIDs. The ITEMIDs are used when generating the postings list 112 to identify those items that contain a particular term, such as the word “Apple.” ITEMIDs identifying other types of files, such as image files or music files, may also be posted to the postings list 112, in which case the ITEMID typically identifies items having metadata containing a particular term.

In one embodiment, the indexing software 102 accumulates postings lists 112 for one or more terms into one or more update sets 120 and, from time to time, flushes the updates sets 120 into one or more index files 122. The postings lists 112 for one or more items may also be stored in a postings file 118. The indexing software 102 may employ one or more indexing tables 114 that comprise one or more term tables, including a two-level table that separates the more frequently occurring terms from the less frequently occurring terms. The tables 114 may also include a postings table that comprises one or more postings lists for the terms that are being indexed. In one embodiment, the indexing software may maintain a live index 116 to contain the most current index. In some cases, updates to an index may be generated in a delta postings list 126 that is a specially marked postings list that may be dynamically applied to an index 122, postings files 118, updates sets 120, or other forms of an index in order to insure that the most current information is returned whenever those indexes are accessed.

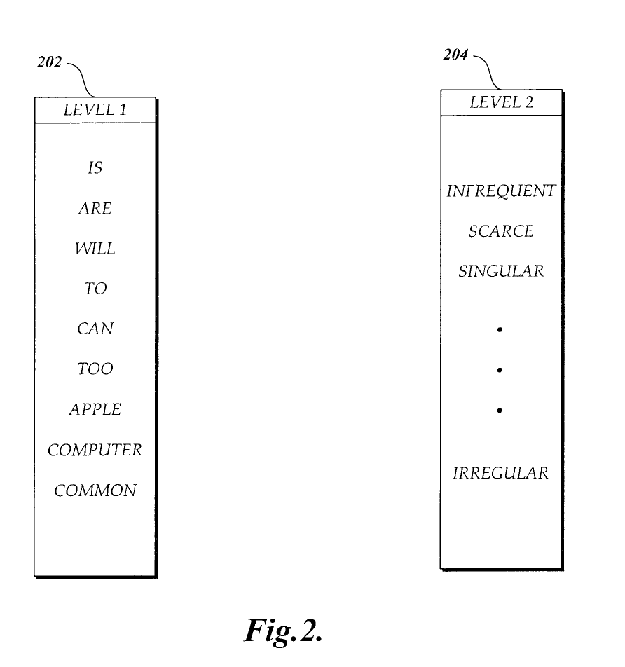

FIG. 2 illustrates two levels of term tables 202/204 used for processing an inverted index according to one exemplary embodiment of the invention. The two level term tables 202/204 are structured such that there is a small table, referred to in FIG. 2 as the LEVEL 1 table 202, used for very quick access to the most commonly occurring terms. In a typical embodiment, the LEVEL 1 table 202 is a fixed size table, such as a 4096 entry table, which typically gives a hit rate of greater than 80 percent. Examples of common terms might be the words “IS” or “ARE” which occur very frequently in text files. In contrast, the LEVEL 2 table 204 is a much larger table that is used to access the less common terms. In a typical embodiment, the LEVEL 2 table 204 may contain as many as 100,000 terms, yet the hit rate is extremely low, with some terms occurring only once or not at all.

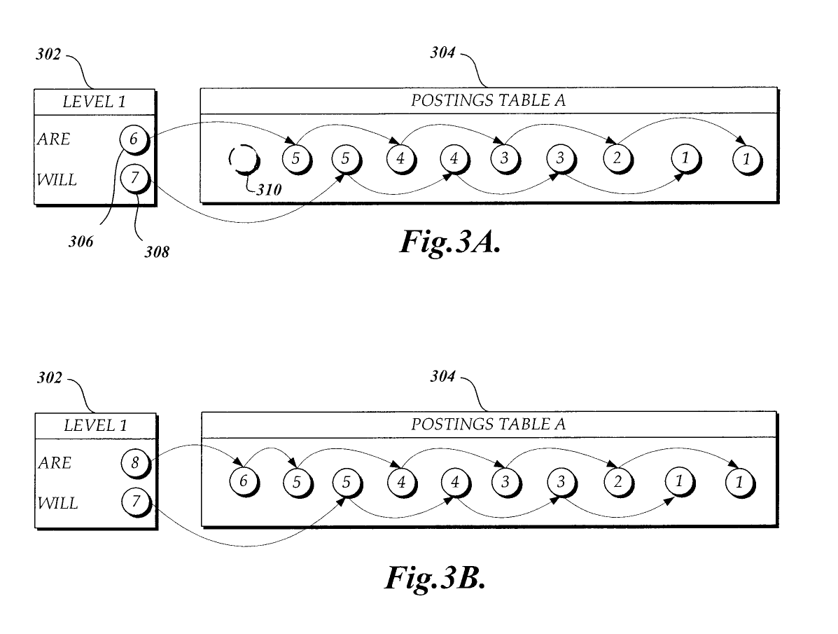

FIGS. 3A-3B illustrate one aspect of processing an inverted index according to one exemplary embodiment of the invention. As illustrated, this example of a LEVEL 1 term table 302 includes immediate postings entries 306/308 for each of the respective term entries “ARE” and “WILL.” In the illustrated example, the term “ARE” has an immediate posting entry of ITEMID “6,” and the term “WILL” has an immediate posting entry of ITEMID “7”.

In a typical embodiment, the previous postings entries stored in a postings table, such as the illustrated postings table A 304. As illustrated, the postings table 304 comprises a storage space having a series of slots 306, some of which are occupied by the postings entries for the terms in the LEVEL 1 term table 302. Each immediate postings entry 306/308 contains a pointer to the previous posting entry for that term, i.e., the previous posted item. As such, the entries in the postings table A 304 form a series of interleaved linked lists. Storing the immediate posting entry in the term table 302 enables the postings table 304 to be updated more efficiently, by simply copying the immediate posting entry 306/308 from the term table 302 to the postings table 304 as needed, and changing the pointers accordingly. It should be noted that the LEVEL 2 term table 204 typically does not include such an immediate posting entry, since it would often be unused. However, in some embodiments the LEVEL 2 table may include such an entry.

In a typical embodiment, the postings table 304 is stored in a postings file 118 in a storage medium. Due to their volatile nature and large size, writing and reading the postings tables 304 to and from the storage medium can consume large amounts of processor time and memory. Therefore, a number of measures may be employed to optimize the processing of the postings tables 304. For example, in a typical embodiment, the previous posting entries are referenced from the new postings entries. As each immediate postings entry 306/308 is moved into the postings table 304, the pointer contained in the entry continues to point to the previous posting entry for that term. This insures that the previous postings entries are not overwritten.

Another measure to optimize processing includes writing the postings table 304 in reverse order, i.e., updating the available slots 306 in the postings table 304 first from the end of the table until reaching the beginning of the table. For example, as illustrated in FIG. 3B, when a new ITEMID “8” is posted for the term “ARE,” the postings entry for ITEMID “6” is copied into the available slot 306, with ITEMID “8” pointing to ITEMID “6,” and ITEMID “6” continuing to point to the previous posting entry ITEMID “5,” and so forth.

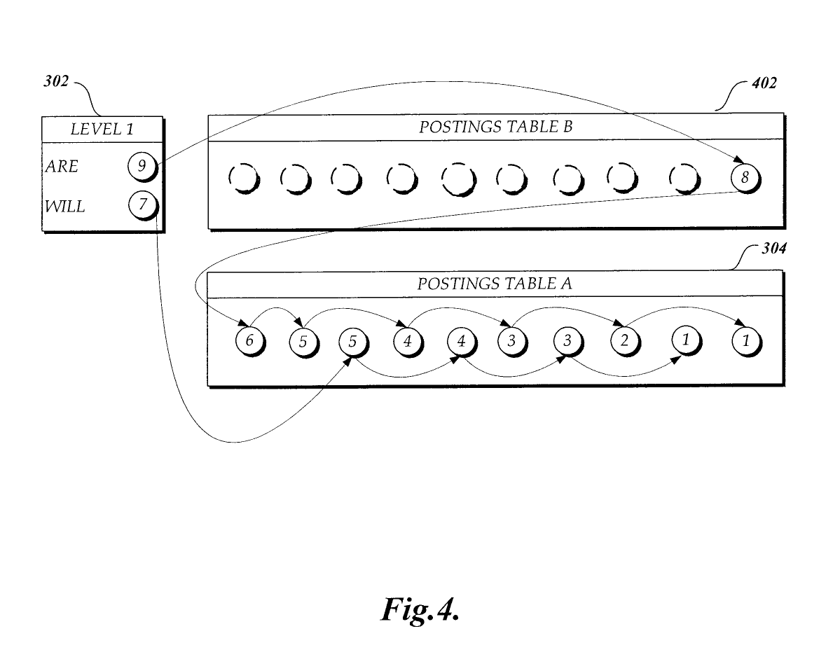

As shown in FIG. 4, when all available slots are filled, a new space, such as postings table B 402 is allocated in addition to the originally allocated space in postings table A 304. Postings table B 402 is updated in the same way as postings table A 304, such that the most recent entry for the term “ARE” in the new postings table B, in this case ITEMID “8” points to the last entry that was made in the old postings table A, in this case ITEMID “6.” The same is true for the entries related to the term “WILL.” In this manner, during access, using the pointers the postings file 118 may be efficiently read in the forward direction, with the occasional large jump backwards in the file, accrued over many forward reads, instead of making many small backwards reads.

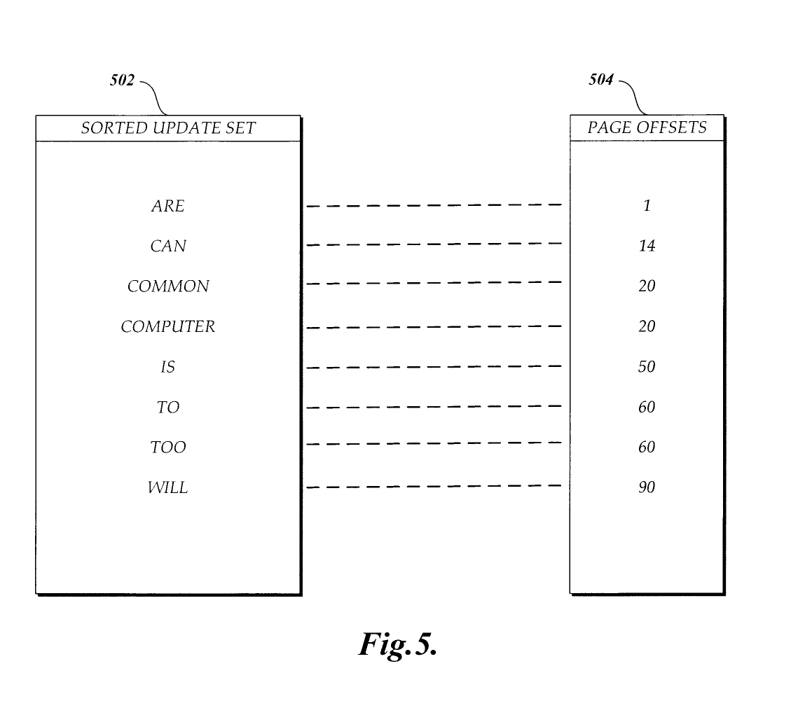

FIG. 5 illustrates another aspect of processing an inverted index according to one exemplary embodiment of the invention. As noted previously, the index files 122 are updated from time to time from the accumulated update sets 120 using a process referred to as flushing the update sets to disk. The flushing process is advantageously used to minimize memory use and optimize disk space. As shown in FIG. 5, the posting entries accumulated in the update set 502 are sorted in string order. Once sorted, various techniques may be used to obtain an associated page offset 504 to the corresponding pages of the index 122 for each of the sorted entries. For example, in one embodiment, the string prefixes in the sorted update set may have been stored in a trie along with the file offsets to a string suffix store that contains the corresponding page offsets. Using the sorted update set, the trie may be walked to obtain the corresponding page offsets. In the illustrated example in FIG. 5, the page offset for the term “ARE” is “1,” for the term “CAN” is “14,” and so forth.

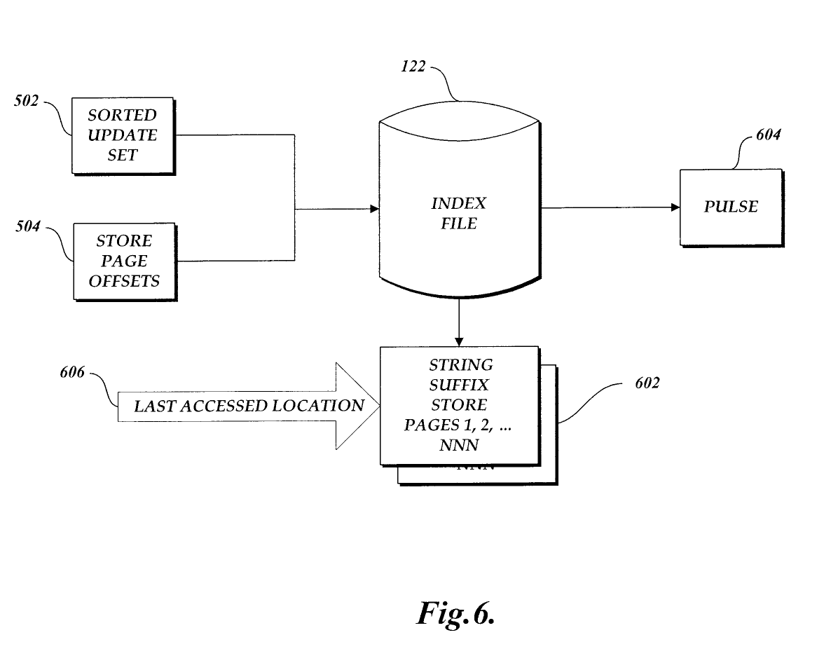

As illustrated in FIG. 6, once obtained, the updates in the update set 502 may be grouped by their associated page offsets 504, and then sorted in page offset major order followed by string minor order. The entries in the update set 502 may then be inserted into the index 122 in page offset major order, string sorted minor order. Thus, during updating the index 122, the string suffix store pages 602 of the index are accessed in disk block order, thus minimizing memory use and maximizing disk bandwidth. Other advantages include the ability to use a single cursor to point to the last accessed location 606 on the last accessed string suffix store page 602, which significantly decreases the search time for string insertion. Moreover, when an update set is flushed to disk, it forms a “pulse” 604 on the disk, in which a given ITEMID occurring in the pulse cannot occur in any other pulse. The characteristic of the pulse may be advantageously used to subsequently retrieve information from the index in an efficient manner.

FIGS. 7-9 are flow diagrams illustrating certain aspects of performing a method of processing an inverted index according to one exemplary embodiment of the invention. In FIG. 7, a method for processing an index using a two level table and a postings file described. The method to be performed begins at block 702, in which the indexing software 102 scans new items for indexing to obtain the terms. At block 704, indexing software 102 employs an algorithm to determine whether to using a LEVEL 1 or LEVEL 2 table to process the term, depending on whether the term is a commonly occurring term or a less frequently occurring term. For example, one such algorithm would keep track of the number of occurrences of each term, and keep the terms that have occurred most in the LEVEL 1 table. One drawback to this algorithm, however, is that if a term begins to occur less frequently as processing continues, the term will still occupy valuable space in the LEVEL 1 table. Therefore, in some embodiments, the number of occurrences of each term is periodically reset or decreased to avoid wasting valuable space on terms that become obsolete.

A second algorithm that may be employed would be to simply move an entry into the LEVEL 1 table whenever it is references. A third algorithm tracks the number of occurrences in the currently process item, and moves a term into the LEVEL 1 table when referenced if it has occurred more in the currently processed document than the term that is currently occupying the contested slot in the LEVEL 1 table. This has the advantage of allowing the composition of terms maintained in the LEVEL 1 table to quickly adapt to changes in language from one item to the next, while limiting thrashing.

Regardless of which algorithm is employed, processing continues at block 706, in which the indexing software 102 copies the currently posted ITEMID from the term table, typically the LEVEL 1 table, into the next available slot in the postings table. This prevents updates to the postings table from unnecessarily taking up space in the processor cache, and allows the operating system to page out the data when the system is under memory pressure.

At block 708, the indexing software 102 updates the pointer in the term table, typically the LEVEL 1 table, to reference the slot into which the currently posted ITEMID was copied. At block 710, the indexing software 102 is then ready to post the new ITEMID to the appropriate term table. Because the LEVEL 1 table is the more active table, and the LEVEL 2 table the less active table, the LEVEL 2 table may be optimized for searching rather than updating without significantly slowing down processing.

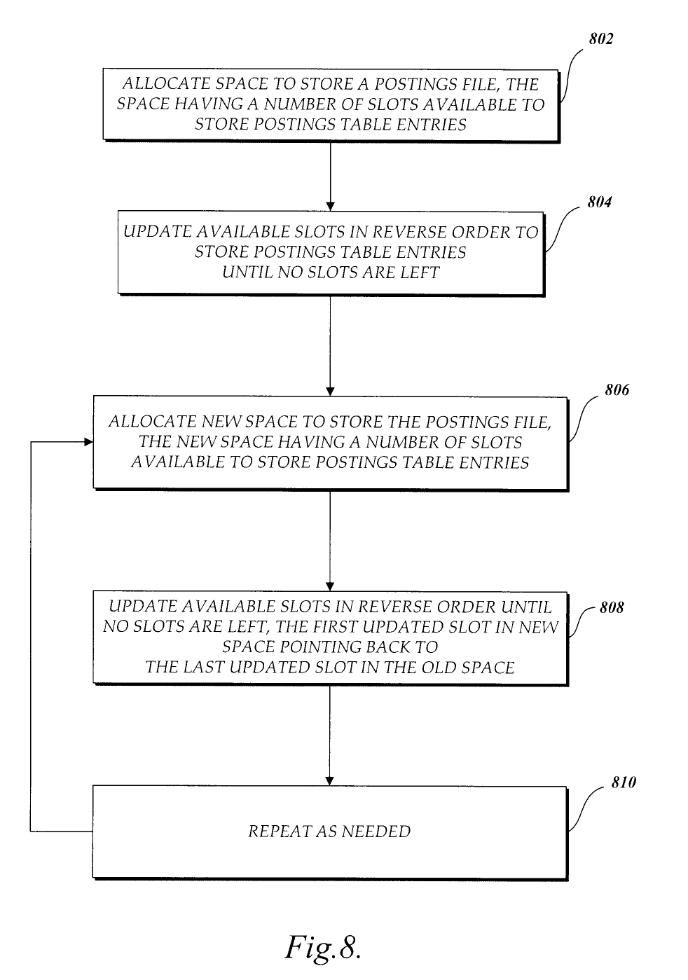

In FIG. 8, a method for processing an index using a postings file is described. At block 802, a method to be performed by indexing software 102 allocates a space in which to store a postings file. The space provides a number of available slots in which to store postings table entries. At processing block 802, the indexing software 102 updates the available slots in reverse order to store postings table entries until no slots are left. Indexing software 102 proceeds at block 806 to allocate a new space to store the postings file, in which the new space has available slots in which to continue to store postings table entries. As before, indexing software 102 updates the available slots in the new space in reverse order until no slots are left. The pointer in the first updated slot in the new space is updated to point back to the last updated slot in the old space, thereby continuing the linked list across to the new space, where each new item in the linked list points to the previous item in the list. At block 810, indexing software 102 repeats the processes in blocks 806 and 808 as needed, until the updates to the postings file are complete.

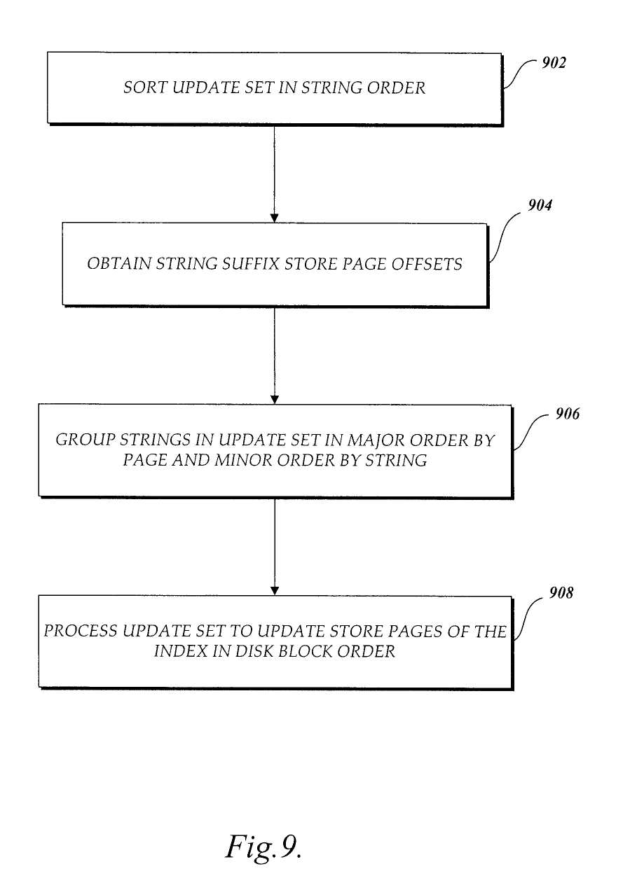

In FIG. 9, a method for processing an index using flushing to update the index to a storage medium is described. At block 902, a method to be performed by indexing software 102 sorts an update set for an index is string order. After sorting, at block 904 the indexing software 102 obtains the page offsets corresponding to each sorted string in the update set. In one embodiment, this may be performed using a trie that contains string prefixes and file offsets into a string suffix store. The indexing software walks the trie in string sorted order to collect the corresponding string suffix store page offsets. Once the offsets are obtained, the indexing software 102 continues at block 906 to group the strings in the update set in major order by the page offset, and in minor order by the string value. Finally, at block 908, the indexing software 102 processes the update set to update the store pages of the index in disk block order. Updating the index in this manner provides a number of advantages, including a reduction in the time needed to search the index for the proper location in which to insert a string.

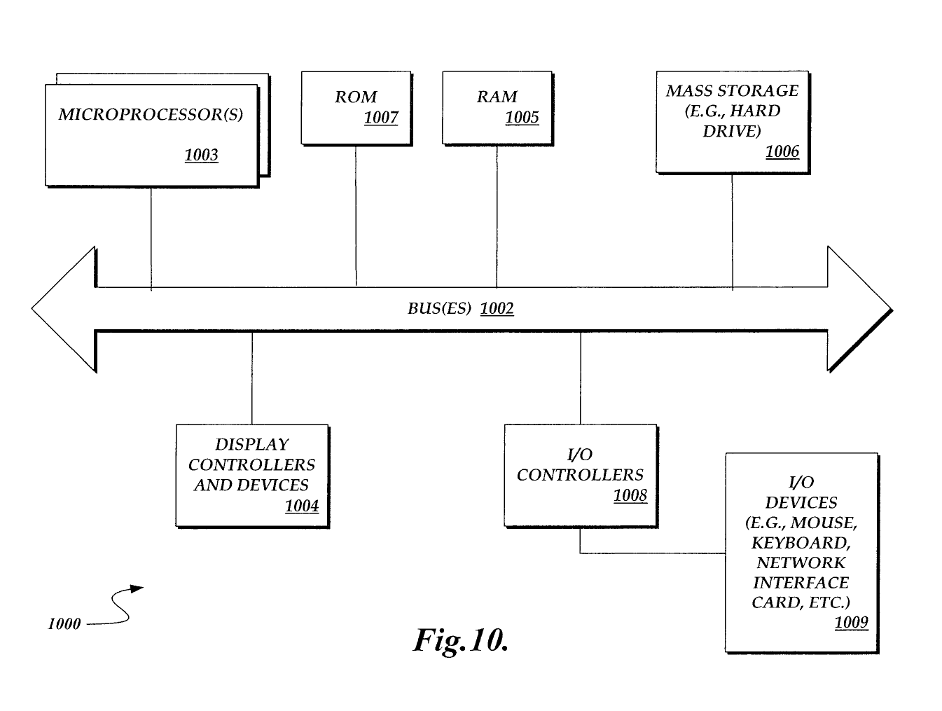

FIG. 10 illustrates an example of a typical computer system which may be used with the present invention. Note that while FIG. 10 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention. The computer system of FIG. 10 may, for example, be a Macintosh computer from Apple Computer, Inc.

As shown in FIG. 10, the computer system 1001, which is a form of a data processing system, includes a bus 1002 which is coupled to a microprocessor(s) 1003 and a ROM (Read Only Memory) 1007 and volatile RAM 1005 and a non-volatile memory 1006. The microprocessor 1003 may be a G3 or G4 microprocessor from Motorola, Inc. or one or more G5 microprocessors from IBM. The bus 1002 interconnects these various components together and also interconnects these components 1003, 1007, 1005, and 1006 to a display controller and display device 1004 and to peripheral devices such as input/output (I/O) devices which may be mice, keyboards, modems, network interfaces, printers and other devices which are well known in the art. Typically, the input/output devices 1009 are coupled to the system through input/output controllers 1008. The volatile RAM (Random Access Memory) 1005 is typically implemented as dynamic RAM (DRAM) which requires power continually in order to refresh or maintain the data in the memory. The mass storage 1006 is typically a magnetic hard drive or a magnetic optical drive or an optical drive or a DVD RAM or other types of memory systems which maintain data (e.g. large amounts of data) even after power is removed from the system. Typically, the mass storage 1006 will also be a random access memory although this is not required. While FIG. 10 shows that the mass storage 1006 is a local device coupled directly to the rest of the components in the data processing system, it will be appreciated that the present invention may utilize a non-volatile memory which is remote from the system, such as a network storage device which is coupled to the data processing system through a network interface such as a modern or Ethernet interface. The bus 1002 may include one or more buses connected to each other through various bridges, controllers and/or adapters as is well known in the art. In one embodiment the I/O controller 1008 includes a USB (Universal Serial Bus) adapter for controlling USB peripherals and an IEEE 1394 controller for IEEE 1394 compliant peripherals.

It will be apparent from this description that aspects of the present invention may be embodied, at least in part, in software. That is, the techniques may be carried out in a computer system or other data processing system in response to its processor, such as a microprocessor, executing sequences of instructions contained in a memory, such as ROM 1007, RAM 1005, mass storage 1006 or a remote storage device. In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the microprocessor 1003.

What is claimed is:

1. A machine implemented method of indexing, the method comprising:
storing more frequently occurring terms in a first table of an inverted index, the first table optimized for updating;
storing less frequently occurring terms in a second table, the second table not optimized for updating;
posting an item in which a more frequently occurring term occurs in the first table;
copying a previously posted item from the first table to a postings table; and
updating the posted item to point to the previously posted item in the postings table.

2. The method of claim 1, wherein posting to the first table is optimized for updating using a posting format that substantially minimizes an amount of memory used to post an item.

3. The method of claim 2, wherein the posting format that substantially minimizes the amount of memory used to post an item comprises:
allocating a space having a number of slots; and
storing each item in a next available slot in reverse order.

4. The method of claim 1, further comprising:
calculating a frequency of a term; and
determining whether the term is a less frequently occurring term or a more frequently occurring term based on the calculated frequency.

5. The method of claim 1, wherein the terms occur in at least one item of a corpus of items.

6. A machine-implemented method of indexing, the method comprising:
allocating a first space on a storage medium for storing a postings file, the postings file containing data representing at least one list of items containing a term;
writing the data to the allocated space in reverse order; and
allocating a second space on a storage medium for storing the postings file, when writing the data would cause the postings file to exceed the amount of space allocated thus far.

7. The machine-implemented method in claim 6, further comprising:
appending new data to old data; and
updating a pointer in the appended new data to point to the old data.

8. The machine-implemented method in claim 6, further comprising storing the data in term order.

9. The machine-implemented method in claim 8, further comprising storing a term identifier with each entry in the list of items containing the term, wherein storing the data in term order includes storing entries in term identifier order.

10. A machine-implemented method of improving indexing, the method comprising:
storing an inverted index on a storage medium, the inverted index mapping a term to an item containing the term;
sorting strings in an update set of strings representing items containing the term in a first order, the first order by a relative location of the term as mapped in the stored inverted index; and
inserting strings from the update set of strings into the stored inverted index in accordance with the first order.

11. The machine-implemented method of claim 10, wherein the relative location of the term as mapped in the inverted index is an offset to a page of the storage medium on which the inverted index has been stored.

12. The machine-implemented method of claim 10, further comprising:
sorting strings in the update set of strings in a second order within the first order, the second order by string order; and
inserting strings from the update set of strings into the stored inverted index in accordance with the second order within the first order.

13. The machine-implemented method of claim 12, wherein inserting strings from the update set of strings into the stored inverted index in accordance with the second order within the first order comprises:
storing a pointer to a last accessed location associated with the relative location of the term as mapped in the stored inverted index; and
inserting strings from the update set of strings using the last accessed location stored in the pointer.
